(19) United States
(12) Patent Application Publication
(10) Pub. No.: US 2026/0043908 A1
(43) Pub. Date: Feb. 12, 2026

(54) MONITORING THE ORIENTATION OF A LASER SCANNER

(71) Applicant: Siemens Aktiengesellschaft, 80333 München (DE)

(72) Inventors: JOHANNES BENKERT, Fürth (DE); RONNY MIELKE, Röttenbach (DE); ALOIS RECKTENWALD, Herzogenaurach (DE); MARKUS SCHAUB, Oberasbach (DE); FLORIAN TERIET, Erlangen (DE); JULIAN VOGEL, Erlangen (DE); BERND WIELENS, Ahaus (DE); FABRICIO DE CARVALHO FERREIRA, Erlangen (DE)

(73) Assignee: Siemens Aktiengesellschaft, 80333 München (DE)

(21) Appl. No.: 19/100,480

(22) PCT Filed: Jun. 28, 2023
(86) PCT No.: PCT/EP2023/067569

§ 371 Date: Jan. 31, 2025

(30) Foreign Application Priority Data
Aug. 2, 2022 (EP) 22188272.3

(51) Int. Cl. G01S 7/497; G01S 7/481; G01S 17/42; G01S 17/88

(52) U.S. Cl. CPC G01S 7/4972; G01S 7/4817; G01S 17/42; G01S 17/88

(57) ABSTRACT

In a method and system for monitoring the orientation of a laser scanner, the laser scanner repeatedly determines distances of the laser scanner from a plurality of measurement points on various planar external surfaces of a measurement object. All measurement objects have the same geometric form having planar external surfaces and are arranged such that the normal vectors of the external surfaces of all measurement objects have defined directions in a fixed first reference system. From the determined distances, the directions of normal vectors of external surfaces of the measurement object are determined, for each measurement object, in a second reference system relating to the laser scanner. A change to the orientation of the laser scanner is inferred when the direction of at least one normal vector in the second reference system changes significantly, for example by more than a specified angle.

The invention relates to a method for monitoring the orientation of a laser scanner, in particular in the environment of a crane.

3D sensors for measuring the surrounding area are used for a multiplicity of different automation solutions in the environment of a crane. Typically, these involve a laser scanner, in particular so-called Lidar sensors (Lidar: an abbreviation representing: light detection and range or light imaging, detection and ranging). Such a laser scanner outputs laser pulses which are reflected in part by objects. From the transit time of a laser pulse between the emission of the laser pulse and the reception of the reflected part of the laser pulse, it is possible to determine the distance of the laser scanner from the location reflecting the respective laser pulse. By varying the directions of the emitted laser pulses, objects in the surrounding area of the laser scanner can be detected (“scanned”).

Sensor systems with multiple laser scanners are often used to increase robustness, accuracy or performance due to perspective effects such as shadows or reflections, as well as for redundancy reasons. Each laser scanner records positions in a reference system related to the laser scanner. These positions must be transformed into a common reference system (“world coordinate system”). For this purpose, it is necessary to initially calibrate the laser scanners, whereby the position and orientation of the laser scanner in relation to the world coordinate system are recorded.

However, the orientation of a laser scanner can change due to material deformation, but also due to impacts and shocks that occur during the operation of the crane, so that the orientation no longer matches the initially recorded calibration. This results in the measuring points recorded by the laser scanner being incorrectly transformed into the world coordinate system. Accordingly, the automation solution works with incorrect position data, causing objects, such as containers, to be recorded in the wrong positions. As a result, the objects can no longer be stacked precisely, for example, but collisions can also occur, which can lead to an interruption in operation.

Currently, the initial calibration of a laser scanner is carried out, for example, with a defined calibration object. In a manual process, this calibration object is measured at a defined position and with a defined orientation using the laser scanner. The calibration object is localized in the sensor data recorded by the laser scanner and the transformation between the reference system related to the laser scanner and the world coordinate system is determined by this. During the operation of the crane, a change in the orientation of the laser scanner is detected when the automation solution no longer functions as expected (reduced accuracy or even system failure). In this case, the orientation of the laser scanner must be checked manually and, if necessary, the laser scanner must be re-calibrated. This means that the crane can no longer be used for the duration of re-calibration and the sensor system must be re-calibrated, involving great effort, for example with the aid of an external measuring system, for example using a theodolite.

DE 10 2008 019 373 A1 discloses a method for calibrating a measuring apparatus of a crane, wherein a container is arranged in such a way that at least one surface of the container lies in a common field of view of at least two 3D sensors of the measuring apparatus that are spaced apart from one another. Using the 3D sensors, one surface of the container is scanned and an orientation of one surface of the container is determined in the reference systems of the 3D sensors. The reference systems of the 3D sensors are synchronized based on the determined orientation of one surface of the container.

The object of the invention is to propose an improved method for monitoring the orientation of a laser scanner, in particular in the environment of a crane.

This object is achieved in accordance with the invention by a method with the features of claim 1.

Advantageous embodiments of the invention are the subject matter of the dependent Claims.

In the method in accordance with the invention for monitoring the orientation of a laser scanner, distances of the laser scanner from multiple respective measuring points on different planar outer surfaces of a respective measuring object are repeatedly determined using the laser scanner, wherein all the measurement objects have the same geometric shape with planar outer surfaces and are arranged in such a way that the normal vectors of the outer surfaces of all the measurement objects have defined directions in a fixed first reference system. From the determined distances, the directions of normal vectors of outer surfaces of the measurement object are determined for each measurement object in a second reference system related to the laser scanner. A change in the orientation of the laser scanner is inferred if the direction of at least one determined normal vector changes significantly, for example by more than a predetermined angle, in the second reference system.

The measurement objects are, for example, conventional containers. The method thus renders it possible to determine the orientation of a laser scanner without a special calibration object. As a result, the method in particular advantageously enables reduced amounts of time required for commissioning systems with laser scanners. Furthermore, the method renders it possible to monitor whether the orientation of a laser scanner has changed during the operation of such a system, and thus whether an initially measured calibration of the laser scanner is still valid.

In the method, the directions of the normal vectors of outer surfaces of a measurement object are determined in the second reference system from a multiplicity of measurement point directions, which are each assigned to a measurement point and are each determined as an eigenvector of a scatter matrix that is formed from coordinates of the measurement point and measurement points adjacent to the measurement point in the second reference system. For example, cluster centroids are determined from the measurement point directions, which are determined for a measurement object, using an agglomerative clustering method, and a cluster centroid is assigned in each case to the outer surfaces of the measurement object.

In the aforementioned embodiment of the method, measurement point directions are thus determined in each case for different measurement points on planar outer surfaces of a measurement object. The distribution of these measurement point directions is analyzed using a clustering method in order to determine the orientations of the outer surfaces of the measurement object, wherein the orientation of an outer surface is determined as a principal orientation of measurement point directions. The cluster centroids determined in the case of the clustering method produce the directions of the normal vectors of the outer surfaces of the respective measurement object.

In a further embodiment of the invention, the method is applied to at least two laser scanners. An incorrect orientation of the laser scanner is inferred if at least two mutually corresponding cluster centroids determined for a measurement object using at least two different laser scanners differ significantly from one another. This embodiment of the invention renders it possible in an advantageous manner to detect a changed orientation of a laser scanner by comparing the cluster centroids determined for different laser scanners.

In a further embodiment of the invention, in the event that the orientation of a laser scanner changes, a transformation matrix is determined that describes the change in orientation. Positions and orientations of objects determined using the laser scanner are then corrected according to the transformation matrix, for example. This renders it possible to correct the positions and orientations of objects determined using the laser scanner by mathematically transforming these positions and orientations with the aid of the transformation matrix, so that the correction is made without re-calibrating the laser scanner. This type of correction is particularly suitable for small changes in the orientation of the laser scanner. In the case of larger changes, it is preferable to re-calibrate the laser scanner.

In a further embodiment of the invention, the measurement objects are cuboid. In particular, containers are suitable as measurement objects.

In a further embodiment of the invention, the laser scanner is a Lidar sensor. This embodiment of the invention takes into account that Lidar is often used to determine the positions and orientations of objects.

In a further embodiment of the invention, the method is carried out in an environment of a crane. In particular, the method can be advantageously used in the environment of a crane which is used to transport containers, since containers are particularly suitable as measurement objects.

The properties, features and advantages of this invention described above, as well as the way in which they are achieved, will become clearer and more understandable in conjunction with the following description of exemplary embodiments, which will be explained in more detail in conjunction with the drawings. In the drawings:

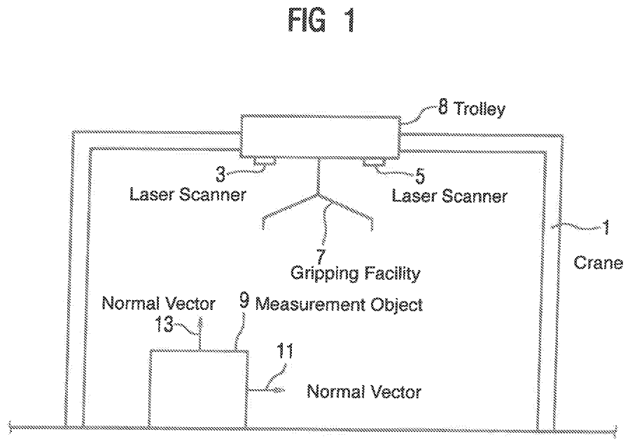

FIG. 1 shows an environment of a crane in which two laser scanners are arranged,

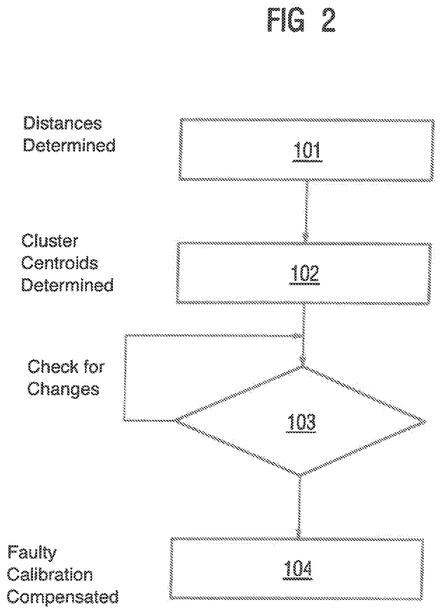

FIG. 2 shows a flow diagram of an exemplary embodiment of the method in accordance with the invention,

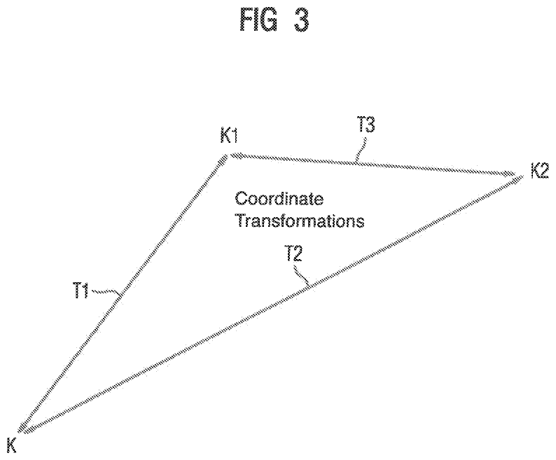

FIG. 3 shows transformations between reference systems.

FIG. 1 (FIG. 1) shows by way of example and schematically an environment of a crane 1 in which two laser scanners 3, 5 are arranged. The crane 1 has a gripping facility 7 and is designed to transport objects. The gripping facility 7 is arranged on a trolley 8 of the crane 1 and can be moved by it. The two laser scanners 3, 5 are also arranged on the trolley 8, for example, but can also be arranged at other points on the crane 1. Also shown are a measurement object 9, which is a cuboid container, and two normal vectors 11, 13 of outer surfaces of the measurement object 9. The measurement object 9 is arranged in such a way that the normal vectors 11, 13 of its outer surfaces have defined directions in a fixed first reference system (“world coordinate system”).

FIG. 2 (FIG. 2) shows a flow chart of an exemplary embodiment of the method in accordance with the invention with method steps 101 to 104 for monitoring the orientation of the laser scanners 3, 5.

In a first method step 101, distances of the laser scanners 3, 5 from multiple respective measuring points on different planar outer surfaces of the measuring object 9 are determined using each laser scanner 3, 5. The scanning areas of the laser scanners 3, 5 need not overlap. It is only necessary for the same outer surfaces of the measurement object 9 to be scanned by both laser scanners 3, 5. Subsequently, a measurement point direction is assigned to each measurement point x. For this purpose, measurement points xᵢ, whose distance from the measurement point x is smaller than a predefined threshold value r are determined for the measurement point x. The set of these measurement points is designated A:

$$A = \{ x \text{?} \vert ‖ x \text{?} - x ‖ < r \}$$

$$\text{?} \text{indicates text missing or illegible when filed}$$

Now, the direction of a normal vector of a plane e is determined as the measuring point direction for the measuring point x, which minimizes the sum of the squared distances between the plane and the points of the set A. For this purpose, the centroid c of the set A is first determined according to

$$c = \frac{1}{5} {\sum }_{i = 1}^{n} x \text{?} x \text{?} ∈ A .$$

$$\text{?} \text{indicates text missing or illegible when filed}$$

It has been assumed here that the set A has the power n. The relative position of the points xᵢ with respect to the centroid c is calculated according to

$$\text{?} = x \text{?} - e .$$

$$\text{?} \text{indicates text missing or illegible when filed}$$

The determined relative point positions yᵢ are now converted into a scatter matrix S according to

$$S = {\sum }_{i = 1}^{n} \text{?} ,$$

$$\text{?} \text{indicates text missing or illegible when filed}$$

wherein [symbol] denotes the dyadic product of the vector yᵢ with itself. The sought-after measuring point direction to the measuring point x is the normalized eigenvector of the smallest eigenvalue of the matrix S and can be calculated in a known manner.

In a second method step 102, for each laser scanner 3, 5 cluster centroids are determined from the measurement point directions, which are determined in the first method step 101, using an agglomerative clustering method, and a cluster centroid is assigned to each outer surface of the measurement object 9. From the cluster centroids determined for the first laser scanner 3, a first transformation T1 is determined, with which positions determined in a reference system K1 related to the first laser scanner 3 are transformed into the world coordinate system K. Accordingly, from the cluster centroids determined for the second laser scanner 5, a second transformation T2 is determined, with which positions determined in a reference system K2 related to the second laser scanner 5 are transformed into the world coordinate system K. Furthermore, a third transformation T3 is determined therefrom, which transforms the positions in the reference system K1 or rather the positions mapped on one another in the reference systems K1 and K2 into positions in the reference systems K2. The transformations T1 and T2 form the initial calibrations of the two laser scanners 3, 5.

FIG. 3 (FIG. 3) shows symbolically the transformations T1 to T3 between the reference systems K, K1, K2.

In a third method step 103, the two first method steps 101, 102 are first repeated for the two laser scanners 3, 5, but where appropriate for another measurement object 9, which is geometrically designed and configured like the measurement object 9 which is used in the two first method steps 101, 102. A check is then performed as to whether the cluster centroids determined for a laser scanner 3, 5 have changed significantly compared to the cluster centroids determined for this laser scanner 3, 5 in the second method step 102, or whether the third transformation T3 between the reference systems K1, K2 has changed significantly, for example by more than a predetermined angle. In the event of a significant change, a change in the orientation of a laser scanner 3, 5 is inferred and a fourth method step 104 is carried out. Otherwise, the third method step 103 is repeated.

In the fourth method step, 104, the faulty calibration detected in the third method step, 103, is at least partially compensated for during normal operation of the crane 1.

For this purpose, it is necessary to store the cluster centroids in the calibrated state. Two conditions can now be optimized using a mathematical optimization term:

### Condition A

On the one hand, the normalized directions assigned to the cluster centroids in each case must be oriented orthogonally to each other, since the associated planes (container surfaces) are orthogonal to each other. For every two different orientation pairs \vec{o_{δ}},\vec{o_{γ}} the following must therefore apply:

$$\text{?} ⊥ \text{?} \to \text{?} \cdot \text{?} = 0$$

$$\text{?} \text{indicates text missing or illegible when filed}$$

### Condition B

Additionally, a transformation matrix R is sought which minimizes the difference between the prevailing cluster position c and the desired cluster position ĉ according to

$${‖ Rc - \text{?} ‖}^{2} = min$$

$$\text{?} \text{indicates text missing or illegible when filed}$$

For this purpose, a solution can be determined using eigenvalue decomposition (Singular Value Decomposition). In this case, the transformation matrix R represents the rotation by which the calibration must be adjusted.

In so doing, it is necessary to take into account the fact that the laser scanner 3, 5—irrespective of their mounting position—maps images with the same scale. The solution no longer needs to be scaled, but the possibility of negative dimensional scaling (−1) must be checked. A reflection is mathematically a valid solution, but can never occur in reality due to the mounting position.

The method has been described above using the example of two laser scanners 3, 5, but can be carried out in an analogous manner for any other number of laser scanners 6, 5, in particular for only one laser scanner 3, 5.

Although the invention has been illustrated and described in detail with the ald of preferred exemplary embodiments, the invention is not limited by the disclosed examples and other variations can be derived from them by those skilled in the art without departing from the scope of the invention.

1.-9. (canceled)

10. A method for monitoring the orientation of a laser scanner, the method comprising:
repeatedly determining distances of the laser scanner from multiple respective measuring points on different planar outer surfaces of a measuring object using the laser scanner, wherein all measurement objects have a same geometric shape with planar outer surfaces and are arranged in such a way that normal vectors of the outer surfaces of all the measurement objects have defined directions in a fixed first reference system;
determining from the determined distances, the directions of the normal vectors of the outer surfaces of the measurement object for each measurement object in a second reference system related to the laser scanner;
determining the directions of the normal vectors of the outer surfaces of a measurement object in the second reference system from a multiplicity of measurement point directions which are each assigned a measurement point and are determined as an eigenvector of a scatter matrix which is formed from coordinates of the measurement point and measurement points adjacent to the measurement point in the second reference system; and
inferring a change in the orientation of the laser scanner when the direction of at least one normal vector changes significantly in the second reference system.

11. The method of claim 10, wherein the significant change is more than a predetermined angle.

12. The method of claim 10, further comprising:
determining cluster centroids from the measurement point directions, which are determined for a measurement object using an agglomerative clustering method; and
assigning a cluster centroid to each outer surface of the measurement object in order to determine the direction of the normal vector of the outer surface.

13. The method of claim 12, further comprising inferring for at least two laser scanners that a laser scanner is incorrectly oriented if at least two mutually corresponding cluster centroids determined for a measurement object using different laser scanners differ significantly from one another.

14. The method of claim 10, further comprising determining a transformation matrix when the orientation of a laser scanner changes, the transformation matrix describing the change in orientation.

15. The method of claim 14, further comprising correcting positions and orientations of objects determined using the laser scanner according to the transformation matrix.

16. The method of the preceding claim 10, further comprising re-calibrating the laser scanner when the orientation of the laser scanner changes.

17. The method of claim 10, wherein the measurement objects are cuboid.

18. The method of claim 10, wherein the measurement objects are containers.

19. The method of claim 10, wherein the laser scanner is a Lidar sensor.

20. The method of claim 10, wherein the laser scanner is arranged on a crane, and the orientation of the laser scanner is monitored during operation of the crane.

21. The method of claim 20, further comprising:
detecting a faulty calibration; and
compensating for the faulty calibration during normal operation of the crane.

22. A crane, comprising:
a trolley;
a gripping facility arranged on the trolley, wherein the trolley and gripping facility are configured to transport a container; and
a laser scanner, wherein an orientation of the laser scanner is monitored by:
repeatedly determining distances of the laser scanner from multiple respective measuring points on different planar outer surfaces of the container using the laser scanner, wherein all containers have a same geometric shape with planar outer surfaces and are arranged in such a way that normal vectors of the outer surfaces of all containers have defined directions in a fixed first reference system,
determining from the determined distances, the directions of the normal vectors of the outer surfaces of the container for each container in a second reference system related to the laser scanner,
determining the directions of the normal vectors of the outer surfaces of a container in the second reference system from a multiplicity of measurement point directions which are each assigned a measurement point and are determined as an eigenvector of a scatter matrix which is formed from coordinates of the measurement point and measurement points adjacent to the measurement point in the second reference system, and
inferring a change in the orientation of the laser scanner when the direction of at least one normal vector changes significantly in the second reference system.
